(19) United States
(12) Patent Application Publication
(10) Pub. No.: US 2026/0177313 A1
(43) Pub. Date: Jun. 25, 2026

(54) SYSTEM FOR TREATING BOIL-OFF GAS

(71) Applicant: INSTITUTE FOR ADVANCED ENGINEERING, Yongin-si (KR)

(72) Inventors: Jongwoong Lim, Yongin-si (KR); Sungho PARK, Yongin-si (KR); Sohmyung CHUNG, Yongin-si (KR); Kwangsoon Choi, Yongin-si (KR); Changhyeong LEE, Busan (KR); Junseok Park, Yongin-si (KR); Sanghee Yoon, Daejeon (KR); Juyoung Yu, Suwon-si (KR)

(73) Assignee: INSTITUTE FOR ADVANCED ENGINEERING, Yongin-si (KR)

(21) Appl. No.: 19/537,404

(22) Filed: Feb. 11, 2026

Related U.S. Application Data
(63) Continuation of application No. PCT/KR2024/011482, filed on Aug. 5, 2024.

(30) Foreign Application Priority Data
Sep. 18, 2023 (KR) 10-2023-0124281

(51) Int. Cl. F25J 1/02; F17C 13/00; F25J 1/00

(52) U.S. Cl. CPC F25J 1/0204; F17C 13/00; F25J 1/0022; F25J 1/0037; F25J 1/005; F17C 2221/012; F17C 2223/033; F17C 2227/0185; F17C 2250/01; F17C 2250/0626

(57) ABSTRACT

A boil-off gas treatment system according to the present invention includes: a storage unit in which a liquefied gas is stored; a subcooling unit connected to the storage unit and configured to subcool boil-off gas generated from the liquefied gas stored in the storage unit to generate subcooled boil-off gas; a compression unit connected to the subcooling unit and configured to receive the subcooled boil-off gas from the subcooling unit and compress the subcooled boil-off gas to generate compressed subcooled boil-off gas; and a phase change unit connected to the compression unit, configured to receive the compressed subcooled boil-off gas from the compression unit, and configured to induce a phase change of the compressed subcooled boil-off gas into a liquid/solid-based slush state.

### CROSS REFERENCE TO PRIOR APPLICATIONS

This application is a continuation application of PCT International Patent Application No. PCT/KR2024/011482 filed on Aug. 5, 2024, which claims priority to Korean Patent Application No. 10-2023-0124281 filed on Sep. 18, 2023, which are all hereby incorporated by reference in their entirety.

### BACKGROUND

The present invention relates to a system for treating boil-off gas.

Interest in and demand for liquefied natural gas (LNG), which has a relatively lower carbon emission compared to conventional fossil fuels, have been rapidly increasing worldwide.

Such LNG is transported in a gaseous state through onshore or offshore gas pipelines, or is transported to remote consumption locations while being stored in a liquefied state in an LNG carrier. In this case, LNG is obtained by cooling natural gas to a cryogenic temperature, and since the volume thereof is significantly reduced compared to a gaseous state, LNG is highly suitable for long-distance transportation by sea.

Meanwhile, an LNG carrier is configured to store LNG and to transport the stored LNG to onshore demand locations. For this purpose, the LNG carrier is provided with a storage tank capable of withstanding the cryogenic temperature of the LNG.

In this case, since the liquefaction temperature of LNG is a cryogenic temperature of approximately −163° C. at atmospheric pressure, LNG is vaporized even when the temperature of the LNG becomes slightly higher than −163° C. at atmospheric pressure. Taking a case of a conventional LNG carrier as an example, although the storage tank of an LNG carrier is thermally insulated, external heat is continuously transferred to LNG. As a result, the LNG is continuously vaporized within the storage tank while being transported by the LNG carrier, thereby generating boil-off gas (BOG) in the storage tank.

The boil-off gas generated inside the storage tank increases pressure within the storage tank, and may accelerate the flow of LNG in response to motion of the LNG carrier, thereby causing structural problems in the storage tank. Accordingly, it is necessary to appropriately treat the boil-off gas generated in the storage tank. In addition, since the boil-off gas represents a loss of LNG stored in the storage tank, treatment of the boil-off gas is an important issue in terms of transportation efficiency of LNG.

Meanwhile, in order to treat boil-off gas generated in the storage tank of the LNG carrier, in the related art, a method of discharging the boil-off gas from the storage tank to the outside for combustion, a method of discharging the boil-off gas from the storage tank to the outside, re-liquefying the boil-off gas through a re-liquefaction apparatus, and then returning the re-liquefied gas to the storage tank, and a method of using the boil-off gas as a fuel used for a propulsion engine of the vessel have been used alone or in combination.

In particular, in the method in which the boil-off gas inside the storage tank is discharged to the outside, re-liquefied through a re-liquefaction apparatus, and then returned to the storage tank, the boil-off gas is expanded using a turbo expander or a pressure-reducing valve in order to re-liquefy the boil-off gas. However, in the case of a turbo expander, although a lower temperature may be reached with a lower compression ratio as compared to a pressure-reducing valve, there is a problem that a large flow rate is required and the system is complex. In addition, in the case of a pressure-reducing valve, although the system is not as complex as that of the turbo expander, there is a problem that a required compression ratio is higher than that of the turbo expander. Furthermore, in order to improve the problems of the conventional turbo expander and pressure-reducing valve, when a multi-stage compressor is used to expand the boil-off gas, more space is required for installing the multi-stage compression, thereby resulting in a problem of poor space utilization.

Accordingly, there is need for development of technologies for a boil-off gas treatment system that is not only compactly configured to provide excellent space utilization, but also enables a temperature required for re-liquefaction of boil-off gas to be readily reached even with a lower compression ratio than conventional systems.

### SUMMARY

Embodiments of the present invention have been devised to solve the above-described conventional problems, and to provide a boil-off gas treatment system that is not only compactly configured to provide excellent space utilization, but also enables a temperature required for re-liquefaction of boil-off gas to be readily reached even with a lower compression ratio than conventional systems.

According to one aspect of the present invention, there is provided a boil-off gas treatment system including: a storage unit in which liquefied gas is stored; a subcooling unit connected to the storage unit and configured to subcool boil-off gas generated from the liquefied gas stored in the storage unit to generate subcooled boil-off gas; a compression unit connected to the subcooling unit and configured to receive the subcooled boil-off gas from the subcooling unit and compress the subcooled boil-off gas to generate compressed subcooled boil-off gas; and a phase change unit connected to the compression unit and configured to receive the compressed subcooled boil-off gas from the compression unit and induce a phase change of the compressed subcooled boil-off gas into a liquid/solid-based slush state.

In addition, the phase change unit may further include: a nozzle unit connected to the compression unit and configured to provide a flow path that induces the compressed subcooled boil-off gas to be discharged at a higher velocity than a velocity at which the compressed subcooled boil-off gas is introduced; and a supply unit connected to the nozzle unit and configured to supply the liquefied gas stored in the storage unit to the nozzle unit.

In addition, the phase change unit may further include a cooling unit that is provided in the nozzle unit and configured to receive the liquefied gas stored in the storage unit and to cool the nozzle unit using cold energy of the liquefied gas.

In addition, the flow path may include: a converging portion formed such that a flow cross-sectional area of the compressed subcooled boil-off gas gradually decreases along a flow direction of the compressed subcooled boil-off gas; a throat portion provided downstream of the converging portion; and a diverging portion provided downstream of the throat portion and formed such that the flow cross-sectional flow of the compressed subcooled boil-off gas gradually increases along the flow direction of the compressed subcooled boil-off gas, wherein the compressed subcooled boil-off gas may be accelerated while passing through the throat portion and the compressed subcooled boil-off gas accelerated through the throat portion may expands while passing through the diverging portion.

In addition, the supply unit may include a transfer pipe connected between the storage unit and the diverging portion and configured to supply the liquefied gas stored in the storage unit into an interior of the diverging portion, wherein the liquefied gas supplied into the diverging portion through the transfer pipe may assist such that an internal temperature of the diverging portion reaches a temperature at which the compressed subcooled boil-off gas is liquefied, or may receive cold energy of the compressed subcooled boil-off gas expanded in the diverging portion to be solidified.

In addition, the cooling unit may be disposed closer to the diverging portion than to the converging portion, installed on an outer surface of the diverging portion, and provided as a heat-exchange coil to receive the liquefied gas stored in the storage unit, wherein the cold energy of the liquefied gas supplied to the heat-exchange coil may assist a phase change of the compressed subcooled boil-off gas within the diverging portion.

In addition, the compressed subcooled boil-off gas re-liquefied in the nozzle unit and the liquefied gas solidified in the nozzle unit may form the liquid/solid-based slush state, and the compressed subcooled boil-off gas in the liquid/solid-based slush state may be returned to the storage unit.

According to embodiments of the present invention, there is an effect that the boil-off gas treatment system is not only compactly configured to provide excellent space utilization, but also enables a temperature required for re-liquefaction of boil-off gas to be readily reached even with a lower compression ratio than that of conventional systems.

### BRIEF DESCRIPTION OF THE DRAWINGS

FIG. 1 is a block diagram illustrating a boil-off gas treatment system according to one embodiment of the present invention.

FIG. 2 is a process diagram illustrating the boil-off gas treatment system of FIG. 1.

FIG. 3 is a conceptual diagram illustrating a phase change unit of the boil-off gas treatment system of FIG. 1.

### DETAILED DESCRIPTION

Hereinafter, exemplary embodiments for implementing the inventive concept of the present invention will be described in detail with reference to the accompanying drawings.

In addition, in describing the present invention, detailed descriptions of related known configurations or functions that may obscure the gist of the present invention will be omitted.

In addition, when it is described that a component is “connected” to another component, it should be understood that the component may be directly connected to the other component or that another component may be interposed therebetween.

The terminology used herein is for the purpose of describing particular embodiments only and is not intended to limit the present invention. Singular expressions include plural expressions unless the context clearly indicates otherwise.

In addition, expressions such as one side, the other side, the upper side, the lower side, and the like are used based on orientations illustrated in the drawings, and may vary if the orientation of the relevant object is changed. For the same reason, some components in the accompanying drawings may be exaggerated, omitted, or schematically illustrated, and the sizes of the respective components do not necessarily reflect actual sizes.

In addition, terms including ordinal numbers, such as first, second, and the like, may be used to describe various components, but such terms do not limit the corresponding components. These terms are used solely for the purpose of distinguishing one component from another.

As used herein, the term “comprising” specifies the presence of stated features, regions, integers, steps, operations, elements, and/or components, but does not preclude the presence or addition of one or more other features, regions, integers, steps, operations, elements, components, and/or groups thereof.

Hereinafter, a boil-off gas treatment system according to one embodiment of the present invention will be described with reference to the accompanying drawings.

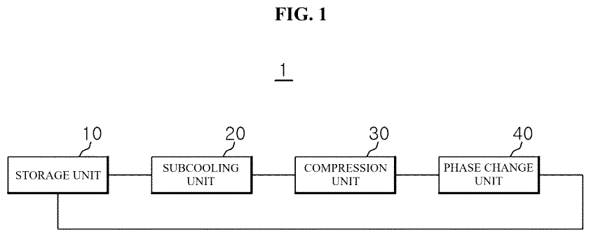

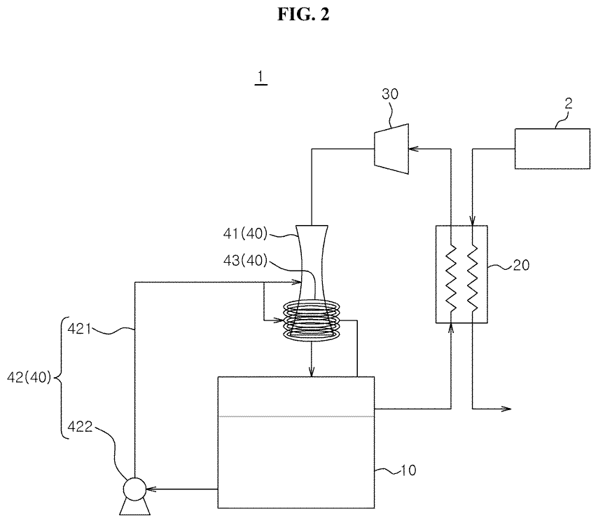

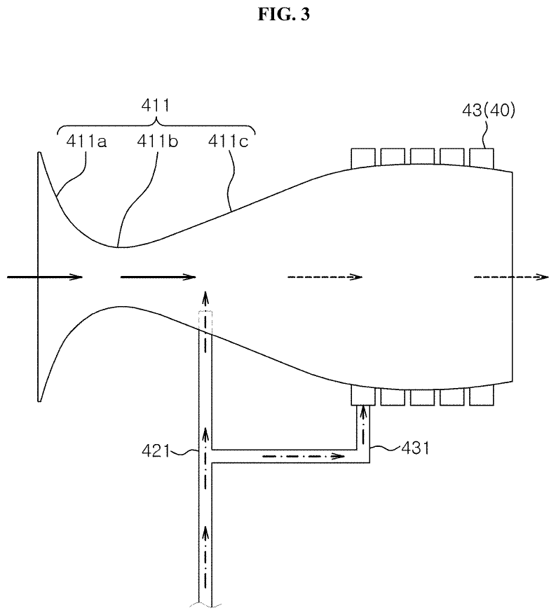

FIG. 1 is a block diagram illustrating a boil-off gas treatment system according to one embodiment of the present invention. FIG. 2 is a process diagram illustrating the boil-off gas treatment system of FIG. 1. FIG. 3 is a conceptual diagram illustrating a phase change unit of the boil-off gas treatment system of FIG. 1.

Referring to FIGS. 1 to 3, a boil-off gas treatment system 1 according to one embodiment of the present invention may include a storage unit 10, a subcooling unit 20, a compression unit 30, and a phase change unit 40.

The storage unit 10 may store liquefied gas in a liquid/solid-based slush state and transport the liquefied gas in the liquid/solid-based slush state to demand locations. Herein, the liquid/solid-based slush state refers to a state in which liquid and solid phases are coexist.

For this purpose, the storage unit 10 may be provided as a storage tank included in a liquefied gas carrier (not shown). The liquefied gas stored in the storage unit 10 may be in a liquid/solid-based slush state, and such liquefied gas in the liquid/solid-based slush state may be densified by solid particles. Accordingly, the storage unit 10 may store and transport a large amount of liquefied gas at a higher storage density than that of conventional systems. In addition, as heat penetrating from the outside is absorbed as the latent heat of fusion of solid particles, a temperature increase of the liquefied gas is suppressed, thereby reducing generation of boil-off gas. Accordingly, the liquefied gas can be stably stored and transported for a long period of time compared to conventional systems.

The subcooling unit 20 may subcool boil-off gas generated from the liquefied gas stored in the storage unit 10 to generate subcooled boil-off gas. For this purpose, the subcooling unit 20 may be connected to the storage unit 10.

In this case, the subcooling unit 20 may subcool the boil-off gas by performing heat exchange between the boil-off gas supplied from the storage unit 10 and a separate refrigerant. Herein, the refrigerant that exchanges heat with the boil-off gas may be supplied from a separate refrigerant supply unit 2 However, this is merely an example, and the inventive concept of the present invention is not limited thereto. For example, the refrigerant that exchanges heat with the boil-off gas may be liquefied gas stored in the storage unit 10. In addition, the refrigerant that exchanges heat with the boil-off gas may be replaced with various refrigerants capable of subcooling the liquefied gas.

The compression unit 30 may receive the subcooled boil-off gas from the subcooling unit 20 and compress the subcooled boil-off gas to generate compressed subcooled boil-off gas. For this purpose, the compression unit 30 may be connected to the subcooling unit 20.

In this case, the compression unit 30 may pressurize the subcooled boil-off gas to lower the temperature of the subcooled boil-off gas to a predetermined temperature, such that the subcooled boil-off gas may undergo a phase change, for example, re-liquefaction, in a nozzle unit 41 of a phase change unit 40, which will be described later. As a result, compressed subcooled boil-off gas having a temperature lower than that of the subcooled boil-off gas may be generated, and such compressed subcooled boil-off gas may reach a supersonic velocity while passing through the nozzle unit 41 of the phase change unit 40. In addition, the compressed subcooled boil-off gas that has reached a supersonic velocity may be expanded while passing through the nozzle unit 41 of the phase change unit 40. The compressed subcooled boil-off gas expanded in this manner may be re-liquefied, or may be used to solidify the liquefied gas supplied to the nozzle unit 41 of the phase change unit 40. This will be described in detail below.

The phase change unit 40 may induce a phase change of the compressed subcooled boil-off gas into a liquid/solid-based slush state. For this purpose, the phase change unit 40 may include a nozzle unit 41, a supply unit 42, and a cooling unit 43.

The nozzle unit 41 may be connected to the storage unit 10, and may provide a flow path 411 that induces the compressed subcooled boil-off gas to be discharged at a velocity higher than a velocity at which the compressed subcooled boil-off gas is introduced. In this case, as illustrated by solid arrows in FIG. 3, the compressed subcooled boil-off gas may be supplied to an upstream end of the nozzle unit 41, and as illustrated by the dashed arrows in FIG. 3, the compressed subcooled boil-off gas that has undergone a phase change into a liquid/solid-based slush state within the nozzle unit 41, for example, within the flow path 411, may be discharged from a downstream end of the nozzle unit 41.

Meanwhile, as illustrated by dash-dotted arrows in FIG. 3, the liquefied gas stored in the storage unit 10 may be supplied through the supply unit 42 to a location between the upstream end and the downstream end of the nozzle unit 41, for example, to a location corresponding to approximately 20% to approximately 80% of a total length of the nozzle unit 41. The liquefied gas supplied to a location corresponding to approximately 20% to approximately 80% of a total length of the nozzle unit 41 is in an incompressible liquid state, and thus, may serve as a refrigerant that assists the internal temperature of the nozzle unit 41 in reaching a temperature at which the compressed subcooled boil-off gas can be liquefied. In addition, the liquefied gas supplied to a location corresponding to approximately 20% to approximately 80% of a total length of the nozzle unit 41 may exchange heat with the compressed subcooled boil-off gas whose temperature has been lowered within the nozzle unit 41, thereby being solidified. This will be described in detail below.

In this case, the flow path 411 may be composed of a converging portion 411a, a throat portion 411b, and a diverging portion 411c.

The converging portion 411a may accelerate the compressed subcooled boil-off gas to the speed of sound. For this purpose, the converging portion 411a may be formed such that a flow cross-sectional area of the compressed subcooled boil-off gas may gradually decrease along a flow direction of the compressed subcooled boil-off gas.

The compressed supercooled boil-off gas accelerated to the speed of sound in the converging portion 411a may flow to the diverging portion 411c, passing through the throat portion 411b provided downstream of the converging portion 411a, and may be further accelerated to a supersonic velocity in the diverging portion 411c.

For this purpose, the diverging portion 411c may be provided downstream of the throat portion 411b and may be formed such that the flow cross-sectional area of the compressed subcooled boil-off gas may gradually increase along the flow direction of the compressed subcooled boil-off gas. In other words, in a supersonic flow region, the diverging portion 411c may further increase a velocity of the compressed subcooled boil-off gas that has reached a supersonic velocity by utilizing a characteristic in which the velocity increases as a flow cross-sectional area increases, and, when the supersonic compressed subcooled boil-off gas is expanded, the diverging portion 411c may significantly reduce the pressure and temperature of the compressed subcooled boil-off gas.

Conventionally, in order to re-liquefy boil-off gas, the boil-off gas has been expanded using a turbo expander or a pressure-reducing valve to lower the temperature of the boil-off gas. However, there have been problems that a compression ratio required to lower the temperature of the boil-off gas to an appropriate level increases, resulting in increased power consumption of a compressor or a need to secure a larger installation space. Furthermore, even when a multi-stage compressor has been used to compensate for these problems, additional problems has arisen in that more space is required for installation of the multi-stage compressor.

However, in the present embodiment, since the boil-off gas is expanded to a supersonic state through the nozzle unit 41, the temperature of the compressed subcooled boil-off gas is significantly reduced. Accordingly, a desired temperature can be reached even with a lower compression ratio than that of a conventional turbo expander or a pressure-reducing valve, thereby reducing power consumption of the compression unit 30 and securing economic efficiency in re-liquefaction as compared to conventional systems. In addition, since the nozzle unit 41 can be installed in a relatively smaller space than conventional turbo expanders or multi-stage compressors, space utilization may be increased in space-limited locations, such as liquefied gas carriers.

The supply unit 42 may supply the liquefied gas stored in the storage unit 10 to the nozzle unit 41. The liquefied gas supplied to the nozzle unit 41 through the supply unit 42 may serve as a refrigerant that assists a phase change of the compressed subcooled boil-off gas within the nozzle unit 41. In addition, the liquefied gas supplied to the nozzle unit 41 through the supply unit 42 may receive cold energy of the compressed subcooled boil-off gas whose temperature has been lowered in the nozzle unit 41, thereby being solidified.

For this purpose, the supply unit 42 may further include a transfer pipe 421 connected between the storage unit 10 and the diverging portion 411c of the nozzle unit 41 to transfer the liquefied gas stored in the storage unit 10 to the diverging portion 411c, and a pump 422 installed in the transfer pipe 421. In this manner, the liquefied gas supplied to the diverging portion 411c through the supply unit 42 may be solidified by receiving cold energy of the compressed subcooled boil-off gas expanded in the diverging portion 411c.

Specifically, since the compressed subcooled boil-off gas expanded in the diverging portion 411c reaches a supersonic velocity and has a low temperature, when the liquefied gas supplied to the diverging portion 411c through the supply unit 42 is in contact with the compressed subcooled boil-off gas expanded in the diverging portion 411c, the compressed subcooled boil-off gas expanded in the diverging portion 411c may function as a refrigerant to solidify the liquefied gas supplied to the diverging portion 411c through the supply unit 42. The liquefied gas solidified in this manner may be returned to the storage unit 10 together with the compressed subcooled boil-off gas re-liquefied through the cooling unit 43, which will be described later. The solidified liquefied gas may not only serve to block radiant heat within the storage unit 10, but also serve to absorb external heat penetrating into the storage unit 10 as latent heat of fusion.

The cooling unit 43 may use cold energy of the liquefied gas supplied from the storage unit 10 to lower a temperature at a downstream end of the nozzle unit 41, thereby assisting in facilitating a phase change of the compressed subcooled boil-off gas within the nozzle unit 41.

For this purpose, the cooling unit 43 may be disposed closer to the diverging portion 411c than to the converging portion 411a of the nozzle unit 41. The cooling unit 43 may receive liquefied gas through a branch pipe 431 that is branched from the transfer pipe 421 transporting liquefied gas stored in the storage unit 10 to the diverging portion 411c. For example, the cooling unit 43 may be provided as a heat-exchange coil installed at a downstream end of the nozzle unit 41.

Specifically, since the compressed subcooled boil-off gas expanded in the diverging portion 411c reaches a supersonic velocity and has a low temperature, when liquefied gas stored in the storage unit 10 is supplied to the cooling unit 43, the liquefied gas supplied to the cooling unit 43 may serve as a refrigerant to further lower the temperature of the compressed subcooled boil-off gas expanded in the diverging portion 411c. When the temperature of the compressed subcooled boil-off gas expanded in the diverging portion 411c is further reduced, re-liquefaction of the compressed subcooled boil-off gas expanded in the diverging portion 411c may be facilitated. The re-liquefied compressed subcooled boil-off gas may be returned to the storage unit 10 together with the solidified liquefied gas.

Meanwhile, in the present embodiment, one example has been described in which liquefied gas supplied to the cooling unit 43 serves as a refrigerant and a downstream end of the nozzle unit 41 is cooled by cold energy of the liquefied gas supplied to the cooling unit 43, thereby assisting in a phase change of the compressed subcooled boil-off gas within the nozzle unit 41. However, the inventive concept of the present invention is not limited thereto. Depending on an installation position of the cooling unit 43, the liquefied gas supplied to the cooling unit 43 may not serve as a refrigerant; instead the compressed subcooled boil-off gas within the nozzle unit 41 may serve as a refrigerant, such that the liquefied gas supplied to the cooling unit 43 may be solidified.

The boil-off gas treatment system 1 having the above-described configuration is not only compactly configured to provide excellent space utilization, but also enables a temperature required for re-liquefaction of boil-off gas to be readily reached even with a lower compression ratio than that of conventional systems.

In addition, since liquefied gas in a liquid/solid-based slush state can be densified by solid particles, a large amount of liquefied gas can be stored at a higher storage density than that of conventional systems.

In addition, when liquefied gas in a liquid/solid-based slush state is transported through a separate pipe, heat penetrating from the outside is absorbed as latent heat of fusion of solid particles. Accordingly, a temperature increase of the liquefied gas is suppressed, generation of boil-off gas is reduced, and the liquefied gas can be stably stored for a long period of time as compared to conventional systems.

Although the embodiments of the present invention have been described with reference to specific exemplary embodiments, the foregoing embodiments are merely illustrative, and the present invention is not limited thereto. Rather, the present invention should be construed as having the broadest scope in accordance with the inventive concept disclosed in the present specification. Those skilled in the art may combine/substitute the disclosed embodiments to implement configurations not explicitly described, but such configurations also do not depart from the scope of the present invention. In addition, those skilled in the art may readily make various changes or modifications to the disclosed embodiments based on the present specification, and it is apparent that such changes or modifications also fall within the scope of the present invention.

What is claimed is:

1. A boil-off gas treatment system, comprising: a storage unit in which a liquefied gas is stored;
a subcooling unit connected to the storage unit and configured to subcool boil-off gas generated from the liquefied gas stored in the storage unit to generate subcooled boil-off gas;
a compression unit connected to the subcooling unit and configured to receive the subcooled boil-off gas from the subcooling unit and compress the subcooled boil-off gas to generate compressed subcooled boil-off gas; and
a phase change unit connected to the compression unit and configured to receive the compressed subcooled boil-off gas from the compression unit and induce a phase change of the compressed subcooled boil-off gas into a liquid/solid-based slush state.

2. The boil-off gas treatment system of claim 1,
wherein the phase change unit includes:
a nozzle unit connected to the compression unit and configured to provide a flow path that induces the compressed subcooled boil-off gas to be discharged at a velocity higher than a velocity at which the compressed subcooled boil-off gas is introduced; and
a supply unit connected to the nozzle unit and configured to supply the liquefied gas stored in the storage unit to the nozzle unit.

3. The boil-off gas treatment system of claim 2,
wherein the phase change unit further includes
a cooling unit provided in the nozzle unit and configured to receive the liquefied gas stored in the storage unit and to cool the nozzle unit using cold energy of the liquefied gas.

4. The boil-off gas treatment system of claim 3,
wherein the flow path includes:
a converging portion formed such that a flow cross-sectional area of the compressed subcooled boil-off gas gradually decreases along a flow direction of the compressed subcooled boil-off gas;
a throat portion provided downstream of the converging portion; and
a diverging portion provided downstream of the throat portion and formed such that the flow cross-sectional area of the compressed subcooled boil-off gas gradually increases along the flow direction of the compressed subcooled boil-off gas,
wherein the compressed subcooled boil-off gas is accelerated while passing through the throat portion, and the compressed subcooled boil-off gas accelerated through the throat portion expands while passing through the diverging portion.

5. The boil-off gas treatment system of claim 4,
wherein the supply unit includes
a transfer pipe connected between the storage unit and the diverging portion and configured to supply the liquefied gas stored in the storage unit into an interior of the diverging portion,
wherein the liquefied gas supplied into the interior of the diverging portion through the transfer pipe assists such that an internal temperature of the diverging portion reaches a temperature at which the compressed subcooled boil-off gas is liquefied, or receives cold energy of the compressed subcooled boil-off gas expanded in the diverging portion to be solidified.

6. The boil-off gas treatment system of claim 4,
wherein the cooling unit is disposed closer to the diverging portion than to the converging portion, is installed on an outer surface of the diverging portion, and is provided as a heat-exchange coil configured to receive the liquefied gas stored in the storage unit,
wherein cold energy of the liquefied gas supplied to the heat-exchange coil assists a phase change of the compressed subcooled boil-off gas within the diverging portion.

7. The boil-off gas treatment system of claim 2,
wherein the compressed subcooled boil-off gas reliquefied in the nozzle unit and the liquefied gas solidified in the nozzle unit form the liquid/solid-based slush state,
and the compressed subcooled boil-off gas in the liquid/solid-based slush state is returned to the storage unit.
